(19) United States
(12) Patent Application Publication
(10) Pub. No.: US 2009/0073713 A1
(43) Pub. Date: Mar. 19, 2009

(54) LED Multidimensional Printed Wiring Board Using Standoff Boards

(76) Inventors: Andrew Z. Glovatsky, Plymouth, MI (US); Steven D. McCarthy, Farmington Hills, MI (US); Richard T. McCarthy, Sterling Heights, MI (US); Joseph Binetti, Howell, MI (US); Donald Pope, South Lyon, MI (US)

Correspondence Address: VISTEON/BRINKS HOFER GILSON & LIONE, 524 South Main Street, Suite 200, Ann Arbor, MI, 48104, US

(21) Appl. No.: 11/851,844

(22) Filed: Sep. 7, 2007

(51) Int. Cl. H01J 61/94; B60Q 1/00; F21V 5/00; F21V 21/00

(52) U.S. Cl. 362/520; 313/1

(57) ABSTRACT

A substrate assembly for use in a lamp has a main printed wiring board and a standoff board. The main printed wiring board has a main surface with one or more LED packages disposed on the main surface and electrically connected thereto. The standoff board is disposed on the main surface of the main printed wiring board. The standoff board has an LED package disposed thereon and conductors to provide an electrical connection between the LED package disposed on the standoff board and the main printed wiring board.

### BACKGROUND

1. Field of the Invention

The present invention generally relates to substrate assemblies. More specifically, the invention relates to substrate assemblies having a plurality of light-emitting diodes (LEDs) integrated therewith.

2. Description of Related Art

Light-emitting diodes (LEDs) are fast becoming a preferable light source for automotive lighting applications, as they consume less power than other forms of light sources, but still provide light output that is acceptable for automotive applications. Currently, multiple LEDs are used as light sources to perform many of the signal lighting applications in motor vehicles. Use of several LEDs in a single application may provide desired styling themes and lit appearances. Lamps used for exterior lighting on motor vehicles often have curved lenses. Using multiple LEDs with curved lenses, however, increases complexity of packaging, which increases the overall cost of the lighting systems. Typically, in order to provide adequate light intensity, an LED must be positioned near the interior surface of the lens.

Conventional ways of positioning LEDs near the interior surfaces of curved lenses include: 1) using multiple planar circuit boards positioned on a heat sink step pattern with wire jumper interconnects; 2) using metal core boards that are formed into a three-dimensional pattern; 3) using a flex circuit to drape LEDs onto a three-dimensional heat sink; and 4) using a lead frame to form LEDs into a three-dimensional pattern on planar patches. All of these methods are equipment intensive, and these types of substrates cost more than standard flat substrates. Assembly of three-dimensional substrates is complicated, which is not compatible with mass production. Unique robots may be required to place parts, and the defect rate for these is relatively high.

One solution to the complexities involved with three-dimensional substrates is a rigid flex printed wiring board. This type of board is relatively stiff, but it may be flexed into a slightly arcuate shape to add contour to a pattern of LEDs disposed on the board. However, a rigid flex board only allows for a slight amount of flexing, which may not be adequate for a lens with more than a slight curve because the LEDs may still not be close enough to the interior surface of the curved lens. If the LEDs are located too far from the interior surface of the lens, the light output may appear dull, which may be undesirable.

### SUMMARY

The present invention provides a non-planar LED arrangement for use in a lamp that is simple and cost-effective to produce, without compromising the amount of light that is visible through a lamp lens.

In one form, a substrate assembly for use in a lamp comprises a main printed wiring board and a standoff printed wiring board. The main printed wiring board has a main surface and at least one first light-emitting diode (LED) package disposed on the main surface and electrically connected thereto. The standoff printed wiring board is disposed on the main surface of the main printed wiring board. The standoff printed wiring board has at least one second LED package disposed thereon.

In another form, a substrate assembly for use in a lamp comprises a main printed wiring board and a standoff board. The main printed wiring board has a main surface and at least one first LED package disposed on the main surface and electrically connected thereto. The standoff board is disposed on the main surface of the main printed wiring board. The standoff board has at least one second LED package disposed thereon and conductors to provide an electrical connection between the at least one second LED package and the main printed wiring board.

In yet another form, a lamp for use in a motor vehicle comprises a main printed wiring board, a standoff board, and a lens. The main printed wiring board has at least one first LED package disposed thereon and electrically connected thereto. The standoff board is disposed on the main surface of the main printed wiring board. The standoff board has at least one second LED package disposed thereon and conductors to provide an electrical connection between the at least one second LED package and the main printed wiring board. The lens has a curved surface and is disposed adjacent to the first and second LED packages. The at least one second LED package is located farther from the main circuit board than the at least one first LED package. Each of the first and second LED packages is located to correspond to the curved surface of the lens.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a perspective view of a lamp embodying the principles of the present invention, the lamp having a substrate assembly;

FIG. 2 is a side view of a portion of the lamp of FIG. 1;

FIG. 3 is a close-up perspective view of another substrate assembly embodying the principles of the present invention;

FIG. 4 is a close-up perspective view of yet another substrate assembly embodying the principles of the present invention; and

FIG. 5 is a close-up perspective view of still another substrate assembly embodying the principles of the present invention.

### DETAILED DESCRIPTION

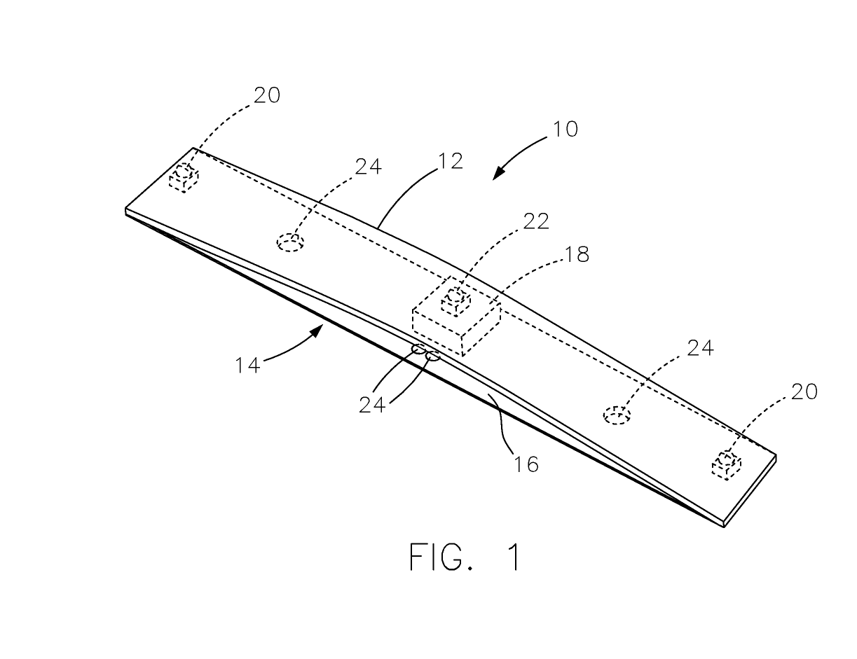

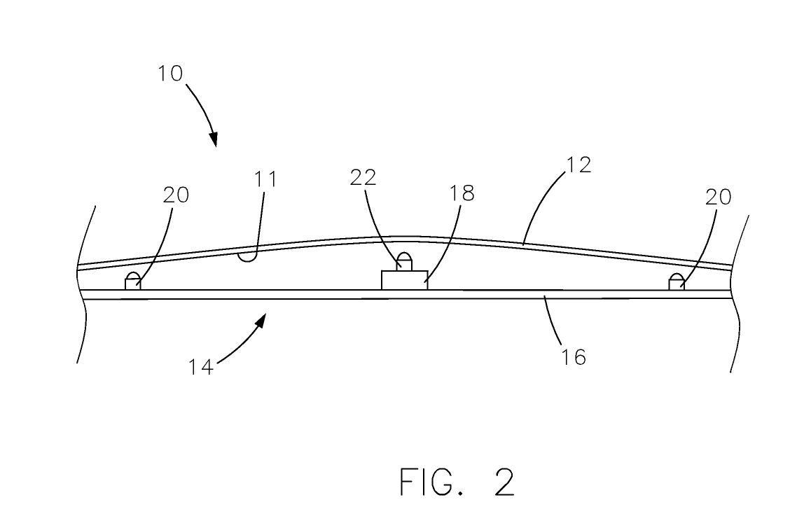

Referring now to FIGS. 1-2, a lamp 10 embodying the principles of the present invention is illustrated therein and designated at 10. The lamp includes a lens 12 disposed adjacent to a substrate assembly 14. The lens 12 has a curved surface, which may suitable for use in light assemblies located on the exterior of a motor vehicle, among other suitable uses.

The substrate assembly 14 includes a main printed wiring board 16 and a standoff board 18. A first set of LED packages 20 are disposed on a main surface of the main printed wiring board 16 and are electrically connected thereto. Another LED package 22 is disposed on the standoff board 18. In this embodiment, the standoff board 18 and LED package 22 are located between the first set of LED packages 20 along the main printed wiring board 16. Because the LED package 22 is located on the standoff board 18, it is farther away (at a z-height) from the main printed wiring board 16 than the first set of LED packages 20. The location or z-height of each LED package 20, 22 corresponds to the curved surface of the lens 12. The LED packages 20, 22 are located a substantially equal distance from the interior 11 of the lens 12, even though the lens 12 has a curved surface.

It should be understood that the substrate assembly 14 could have other combinations of LED packages 20, 22 and standoff boards 18, without falling beyond the spirit and scope of the present invention. For example, other standoff boards 18 may be used to elevate LEDS 22 closer to the interior surface of the lens 12, which may be particularly useful if the lens 12 was provided having a different curvature than that shown in FIGS. 1-2. Further, more than one LED 22 could be located on each standoff board 18.

The main printed wiring board 16 could optionally have apertures 24 for attachment of other components or to attach the lamp 10 to another object. Likewise, the standoff board 18 could also have apertures for attachment (not shown).

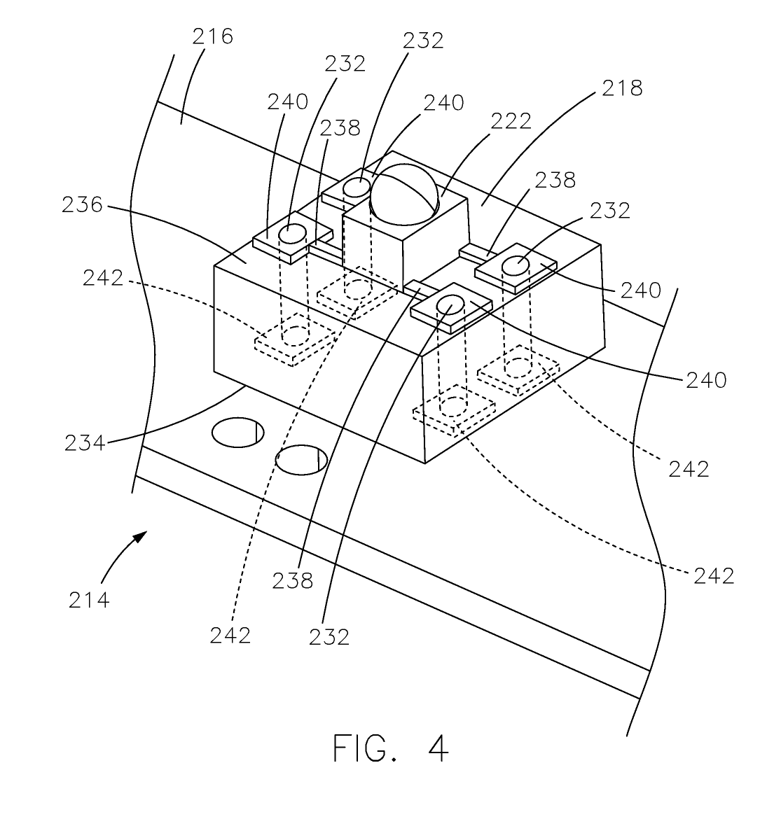

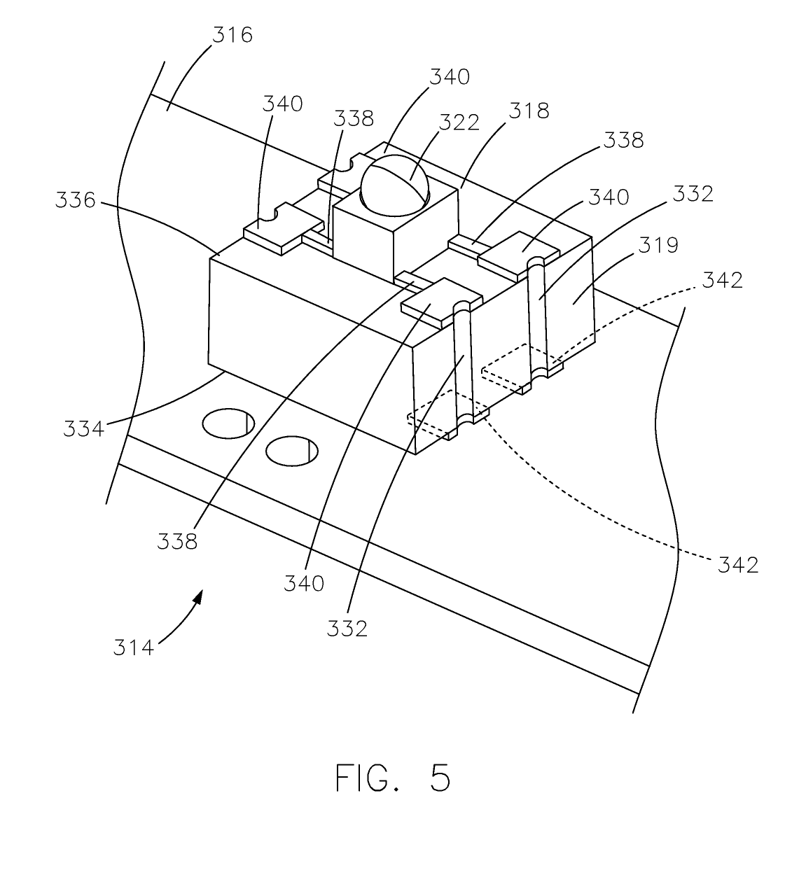

The standoff board 18 is disposed on the main printed wiring board 16 and electrically connected thereto. The standoff board 18 provides an electrical connection between the LED package 22 and the main circuit board 16. The standoff board 18, like the main printed wiring board 16, could also be a printed wiring board, such that the standoff board 18 comprises dielectric material and conductive traces. For example, the standoff board 18 could be a standard FR-4 printed wiring board. Instead of being a printed wiring board, the standoff board 18 could merely comprise a non-conductive substrate and conductors to provide an electrical connection between the LED package 22 and the main printed wiring board 16, which will be described in more detail with reference to FIGS. 4-5.

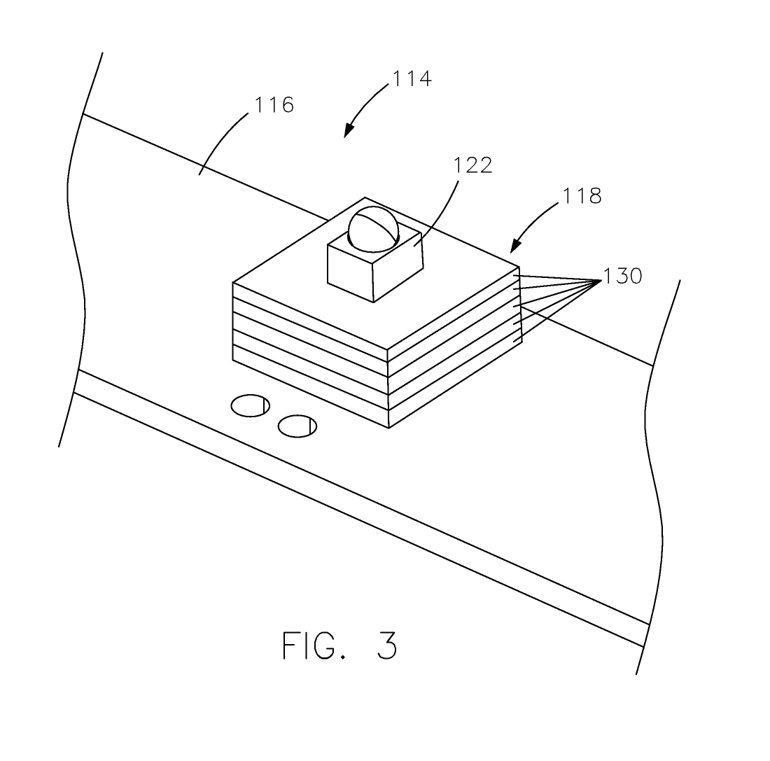

In the embodiment of FIGS. 1-2, the standoff board 18 is shown as a single standoff board 18, which may have a height of about 0.01 inch to about 0.25 inch. However, with reference to FIG. 3, a standoff board 118 could alternatively comprise a plurality of substrates 130, which may be printed wiring boards or other substrates having conductors to provide an electrical connection between a main printed wiring board 116 and an LED package 122 located on the standoff board 118. The plurality of substrates 130 could be soldered together, or they could be attached together in any other suitable manner. Thus, an LED 122 may be located any desired distance from the main printed wiring board 116 by using one or more substrates 130 as a standoff board 118, to provide the desired distance. In other words, the distance that the package LED 122 is located from the main printed wiring board 116 is a function of the number of substrates 130 that the standoff board 118 comprises and the thickness of each substrate 130. For example, if it is desired to locate the LED package 122 at a distance of about one inch from the main printed wiring board 116, four substrates 130 that have a thickness of about 0.25 inch could be attached together to provide the desired one inch distance.

Now with reference to FIG. 4, an enlarged perspective view of a substrate assembly 214 is illustrated, having a standoff board 218 disposed on a main printed wiring board 216. An LED 222 package is disposed on the standoff board 218. The standoff board 218 could be a standard FR-4 printed wiring board, or any other substrate, such as an FR-4 substrate not having printed wiring board traces. The standoff board 218 has portions forming a plurality of vias or holes 232 that extend from a first surface 234 of the standoff board 218 to a second surface 236 of the standoff board 218. As shown in FIG. 4, the first surface 234 is disposed adjacent to the main surface of the main printed wiring board 216, and the second surface 236 is disposed adjacent to the LED package 222. Conducting material, such as metal plating, extends through each hole 232.

In this embodiment, a surface mount LED package 222 is soldered to connect LED leads 238 to conductor pads 240 located on the second surface 236 of the standoff board 218. The conductor pads 240 electrically connect the LED leads 238 to the conducting material that extends through the holes 232. The conducting material is electrically connected to conductor pads 242 located on the first surface 234 of the standoff board 218. Each conductor pad 242 is soldered to a land, conductor pad, or other conducting portion (not shown) located on or in the main printed wiring board 216. This series of electrical connections results in an electrical connection between the LED package 222 and the main printed wiring board 216.

Referring now to FIG. 5, another substrate assembly 314 is illustrated, having a standoff board 318 disposed on a main printed wiring board 316. Like the embodiment of FIG. 4, an LED package 322 is disposed on the standoff board 318, which could be a standard FR-4 printed wiring board, or any other substrate, such as an FR-4 substrate not having printed wiring board traces.

The standoff board 318 has portions forming a plurality of castellations 332 along at least one side 319 of the standoff board 318. In contrast to the holes 232 of FIG. 4, which are passages through the standoff board 218, the castellations 332 form a partial-cylindrical indentation along the side 319 of the standoff board 318. The castellations 332 extend from a first surface 334 of the standoff board 318 to a second surface 336 of the standoff board 318. Conducting material, such as metal plating, extends along the castellations 332 to electrically connect conducting pads 340 located on the second surface 336 to conducting pads 342 located on the first surface 334. This conducting material could be integrally formed with the conducting pads 340, 342, or it could be formed as separate conductors that are attached to the conducting pads 340, 342.

A surface mount LED package 322 is soldered to connect LED leads 338 to conductor pads 340 located on the second surface 336 of the standoff boards 318. The conductor pads 340 electrically connect the LED package 322 to the conducting material that extends along the castellations 332. The conducting material is electrically connected to conductor pads 342 located on the first surface 334 of the standoff board 318. Each conductor pad 342 (and/or the conducting material located in each castellation 332) is soldered to a land, conductor pad, or other conducting material (not shown) located on or in the main printed wiring board 316. This series of electrical connections results in an electrical connection between the LED package 322 and the main printed wiring board 316. The castellations 332 could be provided in addition to the holes 232 of FIG. 4 to provide an electrical connection between the LED package 322 and the main printed wiring board 316, or the castellations 332 alone could provide the electrical connection, as shown in FIG. 5. The castellations 332 allow for visual inspection of the soldering of the standoff board 318 to the main printed wiring board 316.

It should be understood that the standoff board 18, 118, 218, 318 could provide any other suitable configuration to electrically connect an LED package 22, 122, 222, 322 to a main printed wiring board 16, 116, 216, 316. For example, standoff board 18, 118, 218, 318 could carry the electrical connection via traces (not shown) located in and/or on the standoff board 18, 118, 218, 318. Further, the LED package 22, 122, 222, 322 need not be a surface mount device, but could be any suitable type of LED package 22, 122, 222, 322.

The present invention provides a non-complex solution to provide a three-dimensional arrangement of LED packages. Some embodiments of the invention may also be manufactured relatively simply. For example, a high temperature solder could be used to solder the standoff board 18, 118, 218, 318 to the main printed wiring board 16, 116, 216, 316 in a first stage. Then, in a second stage, a low temperature solder could be used to attach the LED package 22, 122, 222, 322 to the standoff board 18, 118, 218, 318. In the alternative, the LED package 22, 122, 222, 322 could first be soldered to the standoff board 18, 118, 218, 318 using a high temperature solder, and in a second stage, the standoff board 18, 118, 218, 318 could be soldered to the main printed wiring board 16, 116, 216, 316 using a low temperature solder. In another alternative, low temperature solder (or high temperature solder) could be used for soldering both the standoff board 18, 118, 218, 318 and the LED package 22, 122, 222, 322. It should be understood that any other suitable manufacturing process could be used, without falling beyond the spirit and scope of the present invention.

As a person skilled in the art will readily appreciate, the above description is meant as an illustration of implementation of the principles this invention. This description is not intended to limit the scope or application of this invention in that the invention is susceptible to modification, variation and change, without departing from the spirit of this invention, as defined in the following claims.

We claim:

1. A substrate assembly for use in a lamp, the substrate assembly comprising:
a main printed wiring board having at least one main surface;
at least one first light-emitting diode (LED) package disposed on the main surface of the main printed wiring board and electrically connected thereto; and
a standoff printed wiring board disposed on the main surface of the main printed wiring board, the standoff printed wiring board having at least one second LED package disposed thereon.

2. The substrate assembly of claim 1, wherein the standoff printed wiring board is comprised of a plurality of printed wiring boards.

3. The substrate assembly of claim 2, wherein the plurality of printed wiring boards is soldered together.

4. The substrate assembly of claim 1, the standoff printed wiring board having portions forming a plurality of holes extending from a first surface to a second surface of the standoff board, the first surface being disposed adjacent to the main surface of the main printed wiring board, and the second surface being disposed adjacent to the at least one second LED package, wherein conducting material extends through each hole to electrically connect the at least one second LED package to the main printed wiring board.

5. The substrate assembly of claim 1, wherein the standoff printed wiring board has portions forming a plurality of castellations, each castellation being located on a side of the standoff printed wiring board and having conducting material disposed therealong to electrically connect the at least one second LED package to the main printed wiring board.

6. The substrate assembly of claim 1, wherein the first and second LED packages are surface mount devices.

7. The substrate assembly of claim 1, wherein the standoff printed wiring board is comprised of a single printed wiring board having a thickness in the range of about 0.01 inch to about 0.25 inch.

8. A substrate assembly for use in a lamp, the substrate assembly comprising:
a main printed wiring board having at least one main surface;
at least one first LED package disposed on the main surface of the main printed wiring board and electrically connected thereto; and
a standoff board disposed on the main surface of the main printed wiring board, the standoff board having at least one second LED package disposed thereon, the standoff board having conductors to provide an electrical connection between the at least one second LED package and the main printed wiring board.

9. The substrate assembly of claim 8, wherein the standoff board is comprised of a plurality of substrates.

10. The substrate assembly of claim 9, wherein the plurality of substrates is soldered together.

11. The substrate assembly of claim 8, the standoff board having portions forming a plurality of holes extending from a first surface to a second surface of the standoff board, the first surface being disposed adjacent to the main surface of the main printed wiring board, and the second surface being disposed adjacent to the at least one second LED package, wherein the conductors extend through the holes to electrically connect the at least one second LED package to the main printed wiring board.

12. The substrate assembly of claim 8, wherein the standoff board has portions forming a plurality of castellations, each castellation being located on a side of the standoff board, each of the conductors extending along a castellation of the plurality of castellations to electrically connect the at least one second LED package to the main printed wiring board.

13. The substrate assembly of claim 8, wherein the first and second LED packages are surface mount devices.

14. The substrate assembly of claim 8, wherein the standoff board comprises a dielectric material.

15. The substrate assembly of claim 8, wherein the standoff board has a thickness in the range of about 0.01 inch to about 0.25 inch.

16. A lamp for use in a motor vehicle, the lamp comprising:
a main printed wiring board having at least one main surface and at least one first LED package disposed on the main surface, the at least one first LED package being electrically connected to the main printed wiring board;
a standoff board disposed on the main surface of the main printed wiring board, the standoff board having at least one second LED package disposed thereon, the standoff board having conductors to provide an electrical connection between the at least one second LED package and the main printed wiring board; and
a lens having a curved surface, the lens being disposed adjacent to the first and second LED packages,
the at least one second LED package being located farther from the main printed wiring board than the at least one first LED package, each of the first and second LED packages being located to correspond to the curved surface of the lens.

17. The lamp of claim 16, the at least one first LED package comprising two first LED packages, the second LED package and the standoff board being located between each of the first LED packages along the main printed wiring board.

18. The lamp of claim 16, wherein each of the first and second LED packages is located substantially equidistant from an interior surface of the lens.

19. The lamp of claim 16, the standoff board having portions forming a plurality of holes extending from a first surface to a second surface of the standoff board, the first surface being disposed adjacent to the main surface of the main printed wiring board, and the second surface being disposed adjacent to the at least one second LED package, wherein the conductors extend through the holes to electrically connect the at least one second LED package to the main printed wiring board.

20. The lamp of claim 16, wherein the standoff board has portions forming a plurality of castellations, each castellation being located on a side of the standoff board, each conductor being disposed along a castellation of the plurality of castellations to electrically connect the at least one second LED package to the main printed wiring board.
